(19) United States
(12) Patent Application Publication
(10) Pub. No.: US 2007/0211580 A1
(43) Pub. Date: Sep. 13, 2007

(54) DRIVING APPARATUS FOR OPTICAL PICKUP UNIT AND OPTICAL DISC DRIVE USING THE SAME

(75) Inventor: Yu-Cheng Ko, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/567,181

(22) Filed: Dec. 5, 2006

(30) Foreign Application Priority Data
Mar. 10, 2006 (CN) 200610034361.3

(51) Int. Cl. G11B 7/085

(52) U.S. Cl. 369/30.1; 369/53.2; 369/53.37

(57) ABSTRACT

An apparatus for driving an optical pickup unit to a discrimination position at which a type of an optical disc can be discriminated includes an actuator, a motor, and a voltage generator. The voltage generator is electrically coupled to the motor for supplying a driving voltage to the motor. The driving voltage includes a first stage having a first voltage value for driving the optical pickup unit to move toward the outermost position, a second stage having a second voltage value for driving the optical pickup unit to move to the innermost position, and a third stage having a third voltage value for driving the optical pickup unit to move from the innermost position to the discrimination position.

### BACKGROUND OF THE INVENTION

1. Field of the Invention

This invention relates to optical disc drives and, more particularly, to an optical pickup unit driving apparatus for moving the optical pickup unit to discriminate optical discs.

2. Description of Related Art

Nowadays, optical discs are widely used for storing information. There are various types of optical discs, such as CDs, DVDs, and Blu-ray Discs, each with various specifications.

An optical disc drive is usually required to be capable of recording and/or reproducing data onto and/or from the various types of optical discs. Therefore, the optical disc drive should discriminate the type of a loaded disc first before setting working parameters corresponding to specifications of the disc.

Referring to FIG. 4, a traditional optical disc drive 10 which is capable of discriminating types of optical discs is illustrated. The optical disc drive 10 includes a spindle motor 12, an optical pickup unit 14, and a driving apparatus 16 for moving the optical pickup unit 14. The driving apparatus 16 includes a sled motor 162, a sled shaft 164, and a sensor 166. An optical disc 20 is arranged on and rotated at a predetermined velocity by the spindle motor 12. The optical pickup unit 14 is disposed to face a read-out surface of the optical disc 20. The optical pickup unit 14 can be moved along a radial direction of the optical disc 20 by the sled motor 162 and the sled shaft 164.

The optical disc 20 includes a plurality of spiral recording tracks extending from an inner side to an outer side thereof. Generally, the data recorded on the optical disc 20 is read from the inner side to the outer side. Therefore, the optical pickup unit 14 is moved from the inner side to the outer side along the radial direction of the optical disc 20 during the reproducing process. Before the reproducing process, the optical disc 20 should be discriminated at a predetermined point (eg. a start point of a data area 22). To discriminate the optical disc, the optical pickup unit 14 is first moved to an innermost position A of the optical disc 20 and then moved from the innermost position A to the predetermined point.

The optical disc drive 10 employs the sensor 166 to detect whether the optical pickup unit 14 has reached the innermost position A. The sensor 166 can be a switch. If the optical pickup unit 14 reaches the innermost position A, the sensor 166 is triggered and generates a detecting signal to indicate that the optical pickup unit 14 has reached the innermost position A. The detecting signal is used to prevent the optical pickup unit 14 from further moving. After reaching the innermost position A, the optical pickup unit 14 goes astern toward the predetermined position to discriminate the optical disc 20.

However, the structure of the traditional optical disc drive 10 is complex as the sensor 166 is critical and must be employed to detect whether the optical pickup unit 14 has reached the predetermined innermost position A.

Therefore, an optical disc drive with a simplified structure is desired.

### SUMMARY OF THE INVENTION

An apparatus for driving an optical pickup unit to a discrimination position at which a type of an optical disc can be discriminated includes an actuator, a motor, and a voltage generator. The optical pickup unit is movable between an innermost position and an outmost position. The actuator is used for moving the optical pickup unit. The motor is used for driving the actuator to move the optical pickup unit. The voltage generator is electrically coupled to the motor for supplying a driving voltage to the motor. The driving voltage includes a first stage having a first voltage value for driving the optical pickup unit to move toward the outermost position, a second stage having a second voltage value for driving the optical pickup unit to move to the innermost position, and a third stage having a third voltage value for driving the optical pickup unit to move from the innermost position to the discrimination position.

A voltage generator generates a driving voltage for driving an optical pickup unit to a discrimination position at which a type of an optical disc can be discriminated. The optical pickup unit is movable between an innermost position and an outmost position. The driving voltage includes a first stage having a first voltage value for driving the optical pickup unit to move toward the outermost position, a second stage having a second voltage value for driving the optical pickup unit to move to the innermost position, and a third stage having a third voltage value for driving the optical pickup unit to move from the innermost position to the discrimination position.

An optical disc drive capable of discriminating an optical disc includes a spindle, an optical pickup unit, an actuator, a motor, and a voltage generator. The spindle motor is used for rotating the optical disc. The optical pickup unit is constructed and arranged for recording and/or reproducing data onto and/or from the optical disc. The actuator is used for moving the optical pickup unit between an innermost position and an outmost position. The motor is used for driving the actuator to move the optical pickup unit. The voltage generator is electrically coupled to the motor for supplying a driving voltage to the motor. The driving voltage includes a first stage having a first voltage value for driving the optical pickup unit to move toward the outermost position, and a second stage having a second voltage value for driving the optical pickup unit to move to the innermost position.

Other advantages and novel features will become more apparent from the following detailed description of preferred embodiments when taken in conjunction with the accompanying drawings, in which:

### BRIEF DESCRIPTION OF THE DRAWINGS

Many aspects of the optical pickup unit driving apparatus can be better understood with reference to the following drawings. The components in the drawings are not necessarily to scale, the emphasis instead being placed upon clearly illustrating the principles of the present device. Moreover, in the drawings, like reference numerals designate corresponding parts throughout the several views.

FIG. 1 is a schematic diagram of an optical disc drive in accordance with an exemplary embodiment, the optical disc drive including a motor;

FIG. 2 is a timing chart showing a waveform of a first driving voltage supplied to the motor of FIG. 1;

FIG. 3 is a timing chart showing a waveform of a second driving voltage supplied to the motor of FIG. 1; and

FIG. 4 is a schematic diagram of a traditional optical disc drive.

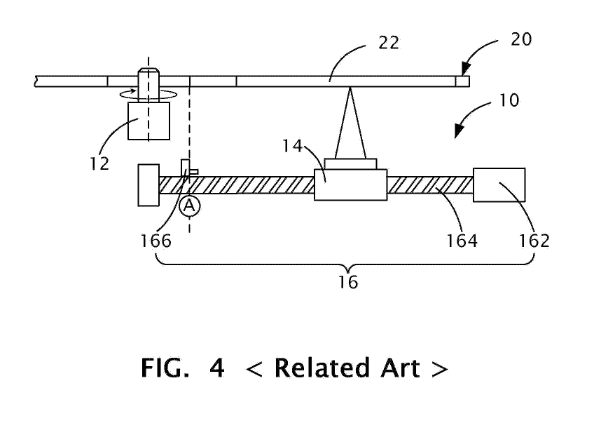

### DETAILED DESCRIPTION OF THE INVENTION

Reference will now be made to the drawings to describe the preferred embodiment of the present optical disc drive, in detail.

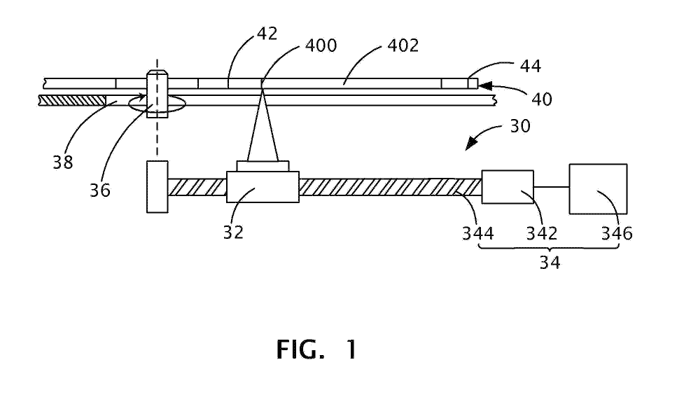

Referring to FIG. 1, an optical disc drive 30 includes an optical pickup unit 32, a driving apparatus 34, and a spindle motor 36. The optical pickup unit 32 generates and focuses light beams on an optical disc 40, and receives light beams reflected by the optical disc 40, thereby recording/reproducing data on/from the optical disc 40.

The driving apparatus 34 used for adjusting positions of the optical pickup unit 32 includes a motor 342, an actuator 344, and a voltage generator 346. The actuator 344 is fixed to a rotor of the motor 342. The optical pickup unit 32 is in contact with the actuator 344 and moves according to a rotation of the actuator 344. In other words, the motor 342 rotates the actuator 344, so as to move the optical pickup unit 32 along the actuator 344. The voltage generator 346 is electrically coupled to the motor 342 and supplies a driving voltage to rotate the motor 342. The driving voltage determines a rotational direction and a rotational speed of the motor 342.

In order to discriminate the type of the optical disc 40 before recording/reproducing the optical disc 40, the optical pickup unit 32 is moved to an innermost position 42 of the optical disc 40. There are at least two states when the optical disc drive 30 needs to discriminate the type of optical disc 40; a first state is when the optical disc drive 30 is powered on and begins initialization with the optical disc 40 already pre-loaded within, and a second state is when a tray (not shown) of the optical disc drive 30 returns to a close state (disc tray within) from an open state (disc tray open) with the optical disc 40 loaded within.

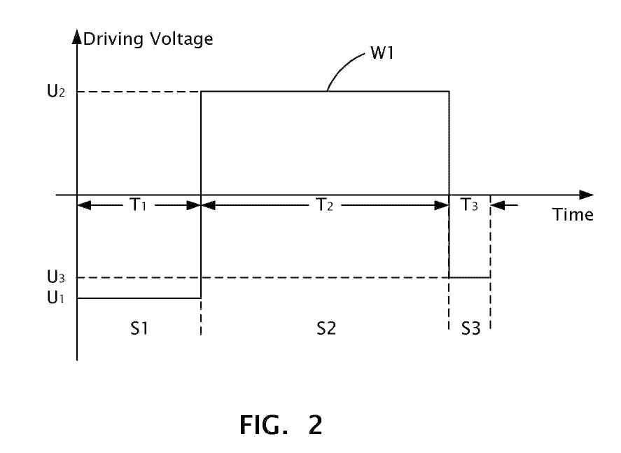

FIG. 2 shows a waveform W1 of a first driving voltage outputted by the voltage generator 346 during the first state with respect to time. The waveform W1 includes a first stage S1 having a duration of a first time interval T1, a second stage S2 having a duration of a second time interval T2, and a third stage S3 having a duration of a third time interval T3.

During the first stage S1, a voltage value of the first driving voltage is U1. After the optical disc drive 30 is powered on and initialized, the motor 342 rotates the actuator 344 with the first driving voltage moving the optical pickup unit 32 towards an outermost position 44 of the optical disc 40 accordingly. Preferably, a first moving distance of the optical pickup unit 32 is equal to or greater than a half of a length between the innermost position 42 and the outermost position 44. It is presumed that it takes a first time period Tp1 for the optical pickup unit 32 to move from the innermost position 42 to the outermost position 44 with the first constant voltage value U1. The first time interval T1 is equal to or greater than a half of Tp1, that is, T1≧0.5Tp1. Therefore, once the first voltage value U1 is determined, the Tp1 can be obtained based on the first constant voltage value U1, and the first time interval T1 can be calculated based on the relationship of T1≧0.5Tp1.

After the first stage S1, the first driving voltage is at the second stage S2 and has a second constant voltage value U2. The motor 342 rotates the actuator 344 with the first driving voltage at the second stage S2 moving the optical pickup unit 32 towards the innermost position 42 of the optical disc 40 accordingly. Preferably, a polarity of the first driving voltage during the second stage S2 is opposite to a polarity of the first driving voltage during the first stage S1, thus the moving direction of the optical pickup unit 32 during the second stage S2 is opposite to the moving direction of the optical pickup unit 32 during the first stage S1 as well.

The second time interval T2 is set to be long enough to move the optical pickup unit 32 to the innermost position 42 with the first driving voltage during the second stage S2. It is presumed that it takes a second time period of Tp2 to move the optical pickup unit 32 from the outermost position 44 to the innermost position 42 with the second voltage value U2. The second time interval T2 is equal to or greater than the Tp2, thereby being capable of moving the optical pickup unit 32 to the innermost position 42 regardless wherever the optical pickup unit 32 is after the second stage S2 of the first driving voltage is applied to the motor 342. Typically, the first voltage value U1 equals to the second voltage value U2, thus the Tp2 equals to the Tp1.

After the optical pickup unit 32 moves to the innermost position 42, the first driving voltage is changed to the third voltage value U3 at the third stage S3. The motor 342 drives the actuator 344 to rotate with the first driving voltage during the third stage S3, and the optical pickup unit 32 moves toward the outermost position 44 of the optical disc 40 accordingly. Preferably, a polarity of the first driving voltage during the third stage S3 is the same as the polarity of the first driving voltage during the first stage S1, thus the optical pickup unit 32 moves toward the outermost position 44. It is presumed that it will take a third time period of Tp3 to move the optical pickup unit 32 from the innermost position 42 to a discrimination position 400 of the optical disc 40. Generally, the beginning of the data area 402 is an ideal discrimination position to start discriminating the type of the optical disc 40. The third time interval T3 is set to be equal to the Tp3.

When the optical disc drive 30 is powered on and the optical disc 40 is detected to be pre-loaded within. The driving apparatus 34 drives the optical pickup unit 32 to sequentially move the first distance toward the outermost position 44, to the innermost position 42, and to the discrimination position 400 of the optical disc 40. Thus discrimination of the optical disc 40 can be implemented without an sensor to detect whether the optical pickup unit 32 has reached the innermost position 42. The structure of the driving apparatus 34 of the optical disc drive 30 is thus simplified.

Optimally, the first time interval T1 equals to the half of the Tp1, thus a longest time during that the motor 342 rotates while the optical pickup unit 32 does not move is 0.5Tp1.

For example, if the optical pickup unit 32 locates at the innermost position 42 when the optical disc drive 30 is powered on, the voltage generator 346 outputs the first driving voltage to drive the motor 342 to rotate at a first direction, thus the driving apparatus 34 drives the optical pickup unit 32 to move toward the outermost position 44 for 0.5Tp1.

Then the voltage generator 346 changes the polarity of the first driving voltage to drive the motor 342 to rotate in a second direction opposite to the first direction, thus driving the optical pickup unit 32 to move toward the innermost position 42.

After a half of the Tp2, the optical pickup unit 32 reaches the innermost position 42. After that, the motor 342 keeps rotating at the second direction until the following half of the Tp2 has elapsed, however, the optical pickup unit 32 remains at the innermost position 42 and does not move. If the optical pickup unit 32 locates at any position other than the innermost position 42 when the optical disc drive 30 is powered on, it will take more than the half of the Tp2 for the optical pickup unit 32 to reach the innermost position 42, then a time period during which the motor 342 is rotating while the optical pickup unit 32 does not move is less than the half of the Tp2.

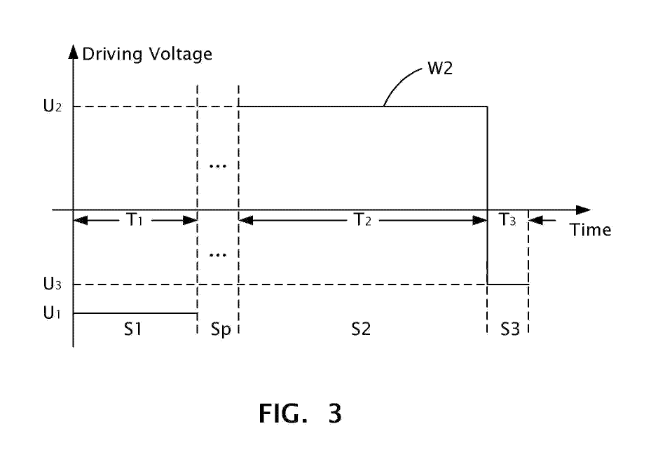

Referring to FIG. 3, a waveform W2 of a second driving voltage outputted by the voltage generator 346 is illustrated. The waveform W2 is supplied in the second state. Compared to the first driving voltage, the second driving voltage further includes a pause stage Sp between the first stage S1 and the second stage S2. At the pause stage Sp, the voltage generator 346 does not output the second driving voltage. That is, the second driving voltage is equal to zero at the pause stage Sp.

When the optical disc drive 30 receives an unload command to unload the tray, the voltage generator 346 outputs the first stage S1 to the motor 342 to move the optical pickup unit 32 toward the outermost position 44. After the optical pickup unit 32 has been moved the first distance, the voltage generator 346 stops outputting the second driving voltage and the optical disc drive 30 starts unloading the tray. A pause time interval Tp of the pause stage Sp is a time from when the optical disc drive 30 starts unloading the tray to when the tray returns to the close position.

When the voltage generator 346 detects that the tray has reached the close position and receives a discrimination command, the second driving voltage corresponding the second stage S2 and the second driving voltage corresponding the third stage S3 are sequentially supplied to the motor 342. Similar to the first driving voltage, the driving apparatus 34 drives the optical pickup unit 32 to move to the innermost position 42 with the second stage S2. Then, the driving apparatus 34 drives the optical pickup unit 32 to move to the discrimination position 400 with the second driving voltage at the third stage S3. Thus discrimination of the optical disc 40 can be implemented. The driving apparatus 34 did not need a switch to detect whether the optical pickup unit 32 has reached the innermost position 42, thus the structure of the driving apparatus 34 of the optical disc drive 30 is simplified.

Furthermore, the pause stage Sp can be arranged between the second stage S2 and the third stage S3. In this case, first, the driving apparatus 34 drives the optical pickup unit 32 to move the first distance toward the outermost position 44. Next, the driving apparatus 34 drives the optical pickup unit 32 to move to the innermost position 42. Then, the motor 342 stops rotating and the tray is unloaded to load the optical disc 40. After the tray carrying the optical disc 40 has reached the close position, the driving apparatus 34 drives the optical pickup unit 32 to move to the discrimination position 400 of the optical disc 40 to perform discrimination of the optical disc 40.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. An apparatus for driving an optical pickup unit to a discrimination position at which a type of an optical disc can be discriminated, the optical pickup unit being movable between an innermost position and an outmost position, the apparatus comprising:
an actuator for moving the optical pickup unit;
a motor for driving the actuator to move the optical pickup unit; and
a voltage generator electrically coupled to the motor for supplying a driving voltage to the motor, the driving voltage comprising a first stage having a first voltage value for driving the optical pickup unit to move toward the outermost position, a second stage having a second voltage value for driving the optical pickup unit to move to the innermost position, and a third stage having a third voltage value for driving the optical pickup unit to move from the innermost position to the discrimination position.

2. The apparatus as claimed in claim 1, wherein the first stage of the driving voltage lasts a first time interval that is equal to or no more than a half of a first period of moving the optical pickup unit from the innermost position to the outermost position with the first voltage value.

3. The apparatus as claimed in claim 1, wherein the second stage of the driving voltage lasts a second time interval that is equal to or greater than a second period of moving the optical pickup unit from the outermost position to the innermost position with the second voltage value.

4. The apparatus as claimed in claim 1, wherein a polarity of the driving voltage during the second stage is opposite to the polarity of the driving voltage during the first stage.

5. The apparatus as claimed in claim 1, wherein the third stage of the driving voltage lasts a third time interval that is equal to a third period of moving the optical pickup unit from the innermost position to the discrimination position.

6. The apparatus as claimed in claim 1, wherein a polarity of the driving voltage during the third stage is opposite to the polarity of the driving voltage during the second stage.

7. The apparatus as claimed in claim 1, wherein the first stage lasts to drive the optical pickup unit to move a first distance toward the outermost position, the first distance being equal to or greater than a half of a distance between the innermost position and the outermost position.

8. The apparatus as claimed in claim 1, wherein the driving voltage further comprises a pause stage having a pause voltage value equal to zero lasts a pause time interval from starting unloading a tray at a close position to the tray returns to the close position.

9. A voltage generator for generating a driving voltage for driving an optical pickup unit to a discrimination position at which a type of an optical disc can be discriminated, the optical pickup unit being movable between an innermost position and an outmost position, the driving voltage comprising:
a first stage having a first voltage value for driving the optical pickup unit to move toward the outermost position;
a second stage having a second voltage value for driving the optical pickup unit to move to the innermost position; and
a third stage having a third voltage value for driving the optical pickup unit to move from the innermost position to the discrimination position.

10. The voltage generator as claimed in claim 9, wherein the first stage lasts a first time interval that is equal to or no more than a half of a first period of moving the optical pickup unit from the innermost position to the outermost position with the first voltage value.

11. The voltage generator as claimed in claim 9, wherein the second stage lasts a second time interval that is equal to or greater than a second period of moving the optical pickup unit from the outermost position to the innermost position with the second voltage value.

12. The voltage generator as claimed in claim 9, wherein the third stage lasts a third time interval that is equal to a third period of moving the optical pickup unit from the innermost position to the discrimination position.

13. The voltage generator as claimed in claim 9, wherein the first stage lasts to drive the optical pickup unit to move a first distance toward the outermost position, the first distance being equal to or greater than a half of a distance between the innermost position and the outermost position.

14. The voltage generator as claimed in claim 9, wherein the driving voltage further comprises a pause stage having a pause voltage value equal to zero lasts a pause time interval from starting unloading a tray to the tray returns to a close position.

15. An optical disc drive capable of discriminating an optical disc, comprising:
a spindle motor for rotating the optical disc;
an optical pickup unit constructed and arranged for recording and/or reproducing data onto and/or from the optical disc;
an actuator for moving the optical pickup unit between an innermost position and an outmost position;
a motor for driving the actuator to move the optical pickup unit; and
a voltage generator electrically coupled to the motor for supplying a driving voltage to the motor, the driving voltage comprising a first stage having a first voltage value for driving the optical pickup unit to move toward the outermost position, and a second stage having a second voltage value for driving the optical pickup unit to move to the innermost position.

16. The optical disc drive as claimed in claim 15, wherein the first stage lasts a first time interval that is equal to or no more than a half of a first period of moving the optical pickup unit from the innermost position to the outermost position with the first voltage value.

17. The optical disc drive as claimed in claim 15, wherein the second stage lasts a second time interval that is equal to or greater than a second period of moving the optical pickup unit from the outermost position to the innermost position with the second voltage value.

18. The optical disc drive as claimed in claim 15, wherein the third stage lasts a third time interval that is equal to a third period of moving the optical pickup unit from the innermost position to the discrimination position.

19. The optical disc drive as claimed in claim 15, wherein the first stage lasts to drive the optical pickup unit to move a first distance toward the outermost position, the first distance being equal to or greater than a half of a distance between the innermost position and the outermost position.

20. The optical disc drive as claimed in claim 15, wherein the driving voltage further comprises a pause stage having a pause voltage value equal to zero lasts a pause time interval from starting unloading a tray at a close position to the tray returns to the close position.
